(19) United States
(12) Patent Application Publication
(10) Pub. No.: US 2006/0184440 A1
(43) Pub. Date: Aug. 17, 2006

(54) Risk-based pricing for rental property

(76) Inventors: Michael A. Britti, Lone Tree, CO (US); Michael Joh Mauseth, Bethesda, MD (US); Robert D. Thornley, Denver, CO (US)

Correspondence Address: HENSLEY KIM & EDGINGTON, LLC, 1660 LINCOLN STREET, SUITE 3050, DENVER, CO, 80264, US

(21) Appl. No.: 11/339,969

(22) Filed: Jan. 25, 2006

Related U.S. Application Data
(60) Provisional application No. 60/647,153, filed on Jan. 26, 2005.

(51) Int. Cl. G06Q 40/00

(52) U.S. Cl. 705/35

(57) ABSTRACT

A risk-based pricing system for computing rental pricing based on the background information on an individual applicant and property-specific information is provided. Rental pricing, such as rent payments and deposits, is computed by determining a risk score corresponding to the applicant. The risk score may be based on a credit score of the applicant and rental history information of the applicant. The risk score is input to a deposit computer that determines an appropriate deposit requirement for the applicant. A property portfolio profile and a population sample set may be used to generate a property risk model, which can be used to further tailor the deposit requirement computed for a given applicant and a given property. An insurance computer can also compute an insurance premium for an insurance product associated with the applicant.

### CROSS-REFERENCE TO RELATED APPLICATIONS

The present invention claims benefit of U.S. Provisional Patent Application No. 60/647,153, entitled “Risk-based Pricing for Rental Property” and filed on Jan. 26, 2005, specifically incorporated by reference for all that it discloses and teaches.

### TECHNICAL FIELD

The invention relates generally to risk management, and more particularly to risk management for rental property.

### BACKGROUND

Rental property managers face a variety of risks when renting property to a renter (e.g., a tenant or a vehicle lessee), including property damage, theft, skipping (e.g., when a tenant leaves the property without paying), and liability. However, in the property rental business, for example, the risks associated with individual tenants differ from tenant to tenant. Accordingly, rent rates and deposits (collectively, “rental prices”) would preferably be set individually for each tenant to maximize the owner's occupancy rates while adequately offsetting the costs associated with such individual risks.

Nevertheless, rental prices are generally set by property managers with little precision or financial finesse, such that the balance between profit (e.g., occupancy and margin) and risk is not optimized. Instead, a property manager may consider past risk costs, revenue needs, and market conditions, and apply a resulting rental price “across the board” for all rental units in a given category (e.g., based on unit, size, location, features, etc.), with limited variations. The result is an inefficient system leading to lower-than-optimal occupancy rates (prices too high), lost revenue (prices too low), and increased risk (when risks associated with individual tenants are not well considered).

One reason for the more “across-the-board” approach taken by property managers is that rental prices and deposits are controlled by the Fair Housing Act and related laws. According to such laws, rental prices and deposits cannot be improperly discriminatory against a tenant's membership in a protected class (e.g., payment policies must be neutral as to race, gender, age, etc.). As such, differences in rental prices and deposits can raise a presumption of illegal discrimination in certain circumstances, exposing the property manager to yet another risk. Nevertheless, the presumption of illegal discrimination in applicant-specific rental pricing can be mitigated considerably if a systematic business-based decision is applied in a manner that is neutral as to the tenant membership in a protected class. Unfortunately, existing approaches fail in this respect, in part because of the lack of proper information and in part because of inadequate rental pricing models.

### SUMMARY

Implementations described and claimed herein address the foregoing problems by providing a system for computing risk-based pricing for rentals based on the background information on an individual applicant and property-specific information. Rental pricing, such as rent payments and deposits, is computed by determining a risk score corresponding to the applicant. The risk score may be dependent on a credit score of the applicant and rental history information of the applicant. The risk score is input to a deposit computer that determines an appropriate deposit requirement for the applicant. An insurance computer can also compute an insurance premium for insurance products associated with the applicant (e.g., insurance in lieu of a security deposit, traditional renter's insurance, liability insurance and others).

In some implementations, a property portfolio profile and a population sample set may be used to generate a property risk model, which can be used to further tailor the deposit requirement computed for a given applicant and a given property. In this manner, a property manager's risk tolerance relative to a given property as well as historical payment performance experiences can be factored into the risk-based pricing.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program.

Other implementations are also described and recited herein.

### BRIEF DESCRIPTIONS OF THE DRAWINGS

FIG. 1 illustrates components in an exemplary risk-based pricing business process.

FIG. 2 illustrates an exemplary risk-based rental pricing computing system.

FIG. 3 illustrates an exemplary screenshot of a configuration screen of a risk-based deposit computing system.

FIG. 4 illustrates with more detail an exemplary risk-based deposit computing system.

FIG. 5 illustrates an exemplary screenshot of a results screen of a risk-based deposit computing system.

FIG. 6 illustrates exemplary operations for computing a risk-based deposit.

FIG. 7 illustrates an exemplary system useful in implementations of the described technology.

### DETAILED DESCRIPTIONS

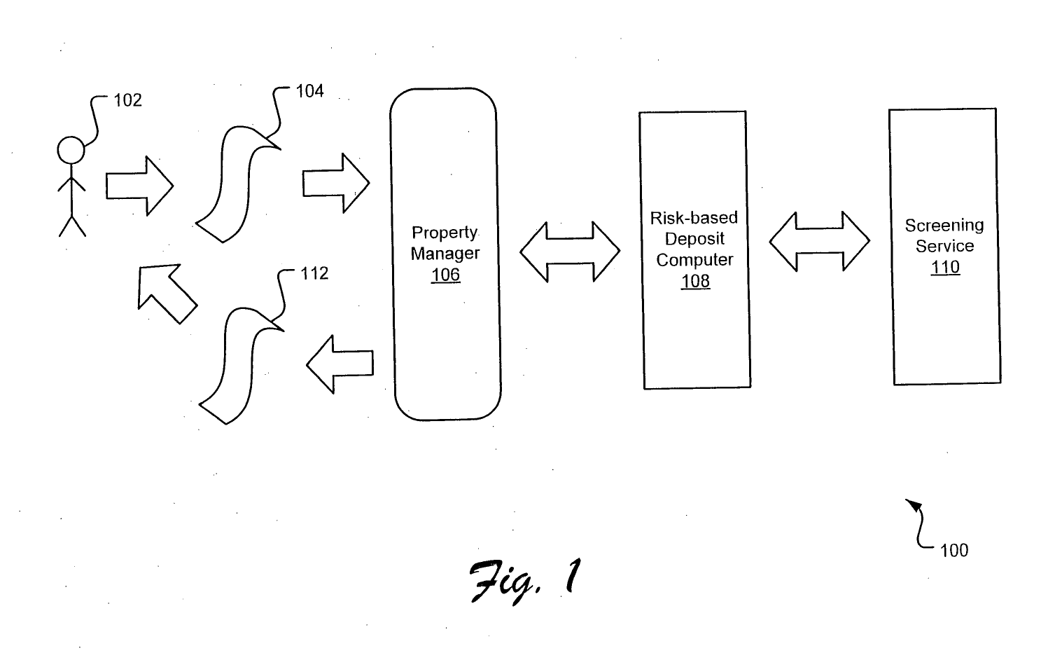

FIG. 1 illustrates components in an exemplary risk-based pricing process 100. An applicant 102 (e.g., a prospective tenant) provides an applicant profile 104 to a property manager 106 (e.g., a leasing agent at an apartment, an equipment leasing agent, etc.). In an apartment rental scenario, for example, the applicant profile 104 would likely be in the form of a tenant application, which includes identification information (e.g., full name, social security number, drivers license number, etc.), financial information (e.g., monthly income, debt level, etc.), rental history information, and other relevant information (e.g., number and ages of resident family members, etc.). Such applications are standard components of a rental process, although implementations of the described risk-based pricing process may employ specific information not included in many standard tenant applications or other stand rental applications.

The property manager 106 inputs information from the applicant profile 104 into the risk-based deposit computer 108, which obtains screening information about the applicant from a screening service 110. In some implementations, a one or more third-party credit services, such as TransUnion, Experian, CreditRetriever, First American, and Equifax, may be employed as the screening service 110. Alternatively, the credit service may be an internal function of the property manager (e.g., a university student housing department may access student financial records within the university system). Other screening services may include leasing history services, criminal background screening services, etc.

The screening service 110 returns a screening data and/or a screening score (e.g., a credit score) to the risk-based deposit computer 108. In one implementation, the screening score may include a consumer credit score based on standard consumer credit scoring. In an alternative implementation, the screening score may include a contribution from the applicant's previous rental history. In this manner, data relating to the applicant's previous evictions, skips, property damage, theft, and other factors can influence the pricing of the rental property for a given applicant. Based on the screening score and the applicant profile 104, as well as other relevant information about the property to be rented, the risk-based deposit computer 108 computes a risk-based deposit amount to be required from the applicant 102.

It should be understood, however, that risk-based deposits are only one component of rental pricing that may be set based on the described process. In one implementation, the rental price may define an upfront deposit recommended to the property manager 106. Alternatively, a rental price may includes a periodic rent payment, a combination of periodic rent payment and deposit, a combination of a rent payment and an insurance premium, or some other combinations of payments required by the property manager (e.g., pet fees, furniture fees, etc.).

The property manager 106 returns an application response 112 to the applicant 102. In some circumstances, the application response 112 may include an acceptance based on standard rental terms (“accept”). In other circumstances, the application response 112 may include an adverse action (“decline”). However, in many circumstances, the application response 112 can be tailored for the individual applicant's profile and the specific property based on the screening score associated with the applicant (“risk-based accept”) and on other information. The computed risk-based pricing terms are specified in the “risk-based accept” response. For example, the application response 112 may specify a specially-computed deposit requirement, a specially-computed periodic rental payment requirement, a specially-computed rental payment/insurance premium combination, or other specially-computed rental pricing fees.

All three types of application responses (e.g. accept, decline, and risk-based accept) may be a result of a risk-based pricing process. It should be understood, however, that a substantial benefit of a risk-based pricing process is obtained from the “risk-based accepts”. Without risk-based pricing, applicants that could qualify as “risk-based accepts” would likely be declined (and the property manager would lose a potential paying occupant in the property) or would be accepted with insufficient protection for the property manager in light of the increased risk. With risk-based pricing, the rental price, and particularly the deposit, can be set to compensate the property manager 106 for the increased risk associated with the applicant 102 based on the screening score.

In an alternative implementation, the applicant 102 may not be willing or able to pay an increased deposit, for example. Therefore, risk-based rental pricing may be employed to compute an insurance premium (e.g., essentially augmenting the periodic rental payment requirement) to shift at least a portion of the increased risk to an insurance provider. This approach reduces the upfront financial burden on the applicant while mitigating the property manager's risk using a deposit insurance product.

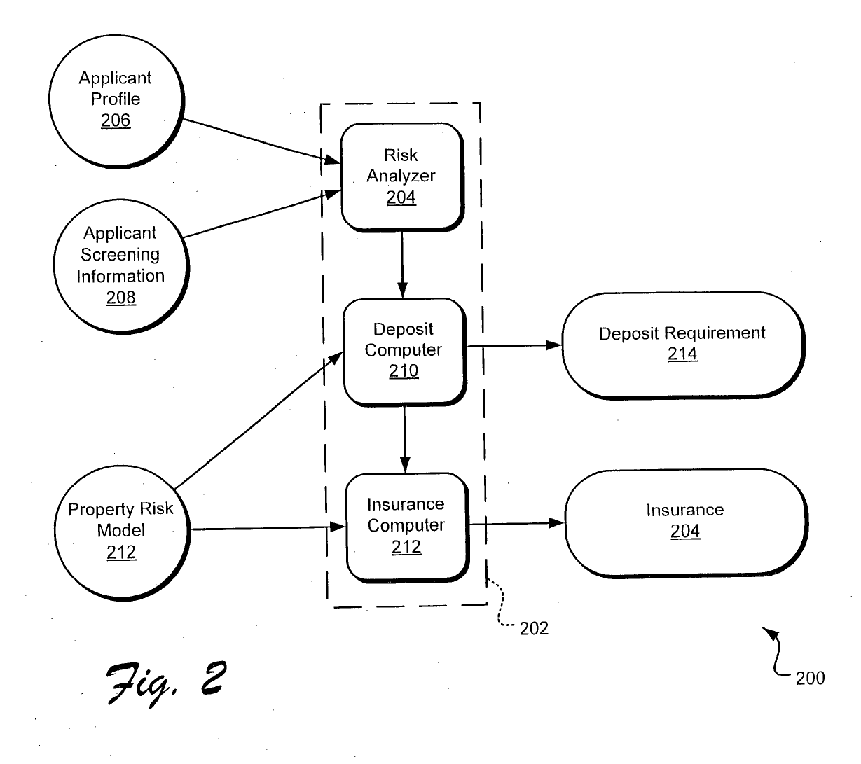

FIG. 2 illustrates an exemplary risk-based rental pricing computing system 200. A computing system 202 (whether stand-alone or distributed) may be employed by a property manager to perform risk-based rental pricing. A risk analyzer module 204 receives as input information from an applicant profile 206, which may include, among other items, applicant identification information, employment information, rental history information, etc. The risk analyzer module 204 also receives applicant screening information 208, which is based in part on background information in the applicant profile 206. In one implementation, the applicant profile 206, or some portion thereof, is sent to a credit bureau, which returns the applicant credit information 208 (e.g., an applicant screening score, an applicant credit score, or raw credit file data) to the risk analyzer 204.

The risk analyzer 204 uses the input information 206 and 208 to compute a “risk score” based on an applicant risk model. In one implementation, the risk score is dependent on the applicant's raw credit information, application information, credit score, and/or rental history. A risk score may be created using data from these sources in a process similar to that in which customized credit scores are generated from a consumer's raw credit file for the mortgage, auto or other consumer lending industries. One chief difference is the risk score may include data from sources that are not necessarily part of the raw consumer credit file, including, but not limited to, data from a rental payment history database. For example, the applicant risk model may pull a raw consumer credit file from one of the three major credit bureaus. Based on that raw file, a custom-built credit scoring model for the apartment industry may yield a score of 610 (the CreditRetriever scoring model is one example). In addition, information from the rental history database may be positive and so 50 points is added to the score. Finally, other raw data from the applicant profile 206, and potentially other available data sources may be calculated that indicate negative credit characteristics and therefore reduce the score by 20 points. The resulting score of 640 would be passed on to the deposit computer 210.

The risk score is communicated to a deposit computer module 210, which applies the risk score to a property risk model 212 in order to compute a deposit requirement 214. The property risk model 212 is generated from a population sample set, which generally characterizes historical risk-benefit trends experienced by the property manager, and a property risk profile, which defines a measure of risk tolerance attributed to a given property by the property manager The property risk model 212 incorporates these inputs so as to correlate a computed risk score pertaining to the applicant with a deposit requirement that will compensate the property manager for accepting the computed risk.

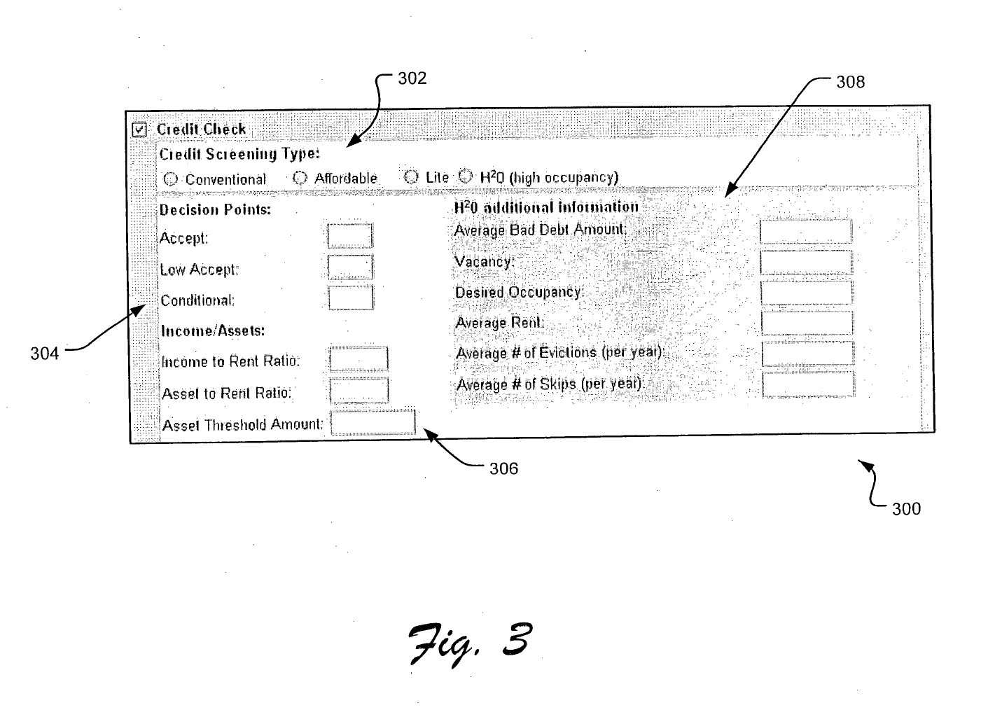

FIG. 3 illustrates an exemplary screenshot 300 of a configuration screen of a risk-based deposit computing system. A property manager can configure the risk-based deposit computing system to meet with current business requirements. The “Credit Screening Type” selections 302 define the type of screening process employed in the current screening session, as described below. There may be any number of credit screening types, each defining a different type of credit scoring model that differs by product type, geography, and/or other characteristics. Four exemplary credit screening types have been broadly identified in one implementation, as follows:
Conventional—This type is the broadest category of rental property type, including low to high income consumers that live in urban or suburban properties where normal credit scoring rules would apply to the applicants.
Affordable—This type includes properties geared toward lower to moderate income tenants that usually have some form of government subsidy, such as industrial revenue bond-backed mortgage, federal loan supports, tax credits, rental payment subsidies or vouchers, and other state or federal subsidies.
Conventional Lite—This type is similar to the “Conventional” type, with a difference being that it is designed for property owners/managers who do not use credit scoring technology to accept or reject applicants.
H²O (high occupancy)—This type is for any type of property that has serious occupancy problems (that is, high vacancy). The vacancy may be due to slow traffic (number of prospects who visit the property), poor local economy, time of year, recent construction, competitiveness, or other factors. This type of product is designed to accept most or perhaps even all of the prospects who come to the property.

The “Decision Points” fields 304 receive user input defining risk score thresholds for different application response categories (e.g., “Accept”, “Low Accept”, “Conditional Accept”, “Decline”). These categories reflect the property manager's risk tolerance. For example, regardless of any risk management features that can be applied to an applicant, a property manager may set a risk score below which no applicant may be accepted. Above that score, other ranking categories of applicants may be applied, each with potentially different risk management characteristics. For example, an applicant categorized as an “Accept” may be accepted with a low deposit (e.g., the standard one-month's-rent). In contrast, an applicant categorized as “Low Accept” may be asked to provide a slightly larger deposit (e.g., 50% more than the standard one-month's-rent), additional reference requirements, or employment verification or other additional information in order to be accepted. As for applicants categorized as “Conditional Accept”, the property manager may require co-signers and substantially larger deposit levels (e.g., double or triple the standard one-month's-rent) to compensate the property manager for the increased perceived risk, as computed by the risk score.

In one implementation, the deposit amounts required in one or more of these categories can be customized for each property and each applicant. For example, based on a property manager's configuration of the risk-based deposit computing system, the lowest risk applicants may be required to pay no deposit while the highest risk applicants may be required to deposit many multiples of a months rent to be accepted. It should be understood that, depending on the property risk defined for a given property, the deposits between these extremes can be modeled by a linear function, a piece-wise linear function, or a non-linear function, or any other statistical or mathematical model.

The “Income/Assets” fields 306 receive user inputs defining how the risk score is computed. The ratios and threshold in the fields 306 provide parameters for the applicant risk model used by the risk analyzer. The contributions of each of these fields to the applicant risk model are described below:
Income to Rent Ratio—This is the ratio of gross monthly income for a prospective tenant to the total lease rent to be charged the resident prospect. If a prospect makes a monthly gross income of $3,000 and rent is $1,000, the income to rent ratio is 3:1. Generally, higher income to rent ratios indicates a stronger ability to pay rent.
Asset to Rent Ratio—For individuals with low incomes but high assets, such as a retired person, an income to rent ratio may not be the best indication of ability to pay and may erroneously indicate that someone is not qualified to pay a particular rent. In those cases, an asset to rent ratio is calculated. Assets are based on bank statements provided by a prospective tenant. The verifiable assets, shown on prospects bank statements, are then compared to the rent. For example, if the total assets held by a prospect is equal to $100,000, and monthly rent is equal to $1,000, then, the asset to rent ratio would be equal to 100:1.
Asset Threshold Amount—The asset threshold amount is the minimum asset level that a tenant prospect or a cosigner for a tenant prospect must have to qualify for a particular lease or for a maximum rent. For example, a landlord may set the minimum verifiable asset threshold for a cosigner of a tenant prospect to rent an apartment unit with a rent of $ 1,000/month at $30,000. The Asset Threshold Amount is an indication of the ability of a cosigner or low-income prospect to take on the lease obligation.
Lease Term—This is the number of months a lease is being signed for. A longer lease obligation may be desirable for a landlord, but, also increases the lease obligation to a tenant or cosigner.
Number of Occupants—The number of occupants increases the wear on a rental unit. There are also legal limits on the number of occupants a unit may have based on local rules and regulations. Local rules and regulations may also limit the number of non-related parties who may occupy a rental unit.
Pets & Pet Deposits—Pets increase the damage to units over time. Often, an additional deposit is required for a tenant to be allowed to have a pet in a leased unit.

The “H2O additional information” fields 308 provide parameters for the property risk model, as described below:
Qualified Traffic—Traffic is the number of tenant prospects who visit a rental property each month. The qualified traffic parameter indicates the applicants who meet the minimum thresholds for applying to rent a unit (e.g. income to rent ratio or asset threshold).
Average Decline Rate or Desired Decline Rate—This rate represents an average measured decline rate or a decline rate objective of a given type of property. A property manager may have different decline rates for different types of properties (or different property locations), relative to the amount of risk (e.g., applicant credit risk) the manager has been willing to take in the past or will be willing to take in the future. This parameter may also be a target set by the property manager to maximize the current risk/return tradeoff.
Average Bad Debt Amount—This is the percentage of rental income for a property that must be written off as bad debt, that is, is uncollectible. A debt is considered uncollectible if it is not paid for a period of time, usually between 90 and 180 days, after the amount is due. The rules for writing off debt are based on GAAP accounting rules.
Optimal Bad Debt Rate—This is the rate at which revenue is maximized by balancing the amount of bad debt against the risk of turning away too many poor credit prospects.
Economic Vacancy—Economic vacancy is shown as a percentage. It is a ratio where the numerator is the actual dollar amount collected in rent for a property over a month or other period and the denominator is the amount of rent that would be collected if that property were fully rented at market rents over that same month or other period. There are other types of vacancy that could be calculated also. Physical vacancy is the total number of days each unit is occupied in a month or other period divided by the product of the total number of units in a property multiplied by the number of days in a month or other period.
Desired Vacancy/Occupancy—This is the percentage of vacancy (or conversely the percentage of occupancy) that the landlord deems is optimal. This is frequently considered to be around 5% vacancy (95% occupancy). The number is usually less than 100% for a number of reasons. Full, or 100% occupancy would often require a landlord to price the units at a property at a very low rate, thus not maximizing the total revenue from the property. Furthermore, not having units available in the marketplace limits a landlord's ability to take advantage of higher rents in a market where rents are rising. Finally, the time it takes to re-rent a unit that becomes vacant, and to make it ready for rental after a tenant departs, virtually ensures that occupancy will never be 100%.
Average Rent—This is the average rent the landlord is actually receiving for each type of apartment unit at a property. Type is usually defined by floor plan, number of bedrooms, number of bathrooms, square footage. Unit amenities may affect price and they include a view, floor level, fireplaces, appliances, and other in-unit differences.
Average # of Evictions (per year)—This is the number of tenants a property has had to evict for violations of the lease each year.
Average # of Skips (per year)—This is the number of residents that left the property without fulfilling their entire lease obligation. For example, if a resident signs a 12-month lease and leaves after 8 months, and does not pay a lease breakage fee or does not fulfill the remaining 4-month rent obligation.
Average Cost of an Eviction—This is the total cost of all evicted tenants in a year, including all cost to re-rent the unit, lost rent, damage to the unit, legal cost, and other cost related to the eviction divided by the number of evictions in a year.
Average Cost of a Skip—This is the total cost of all tenants who slip in a year, including all cost to re-rent the unit, lost rent, damage to the unit, legal cost, and other cost related to the skip divided by the number of skips in a year.

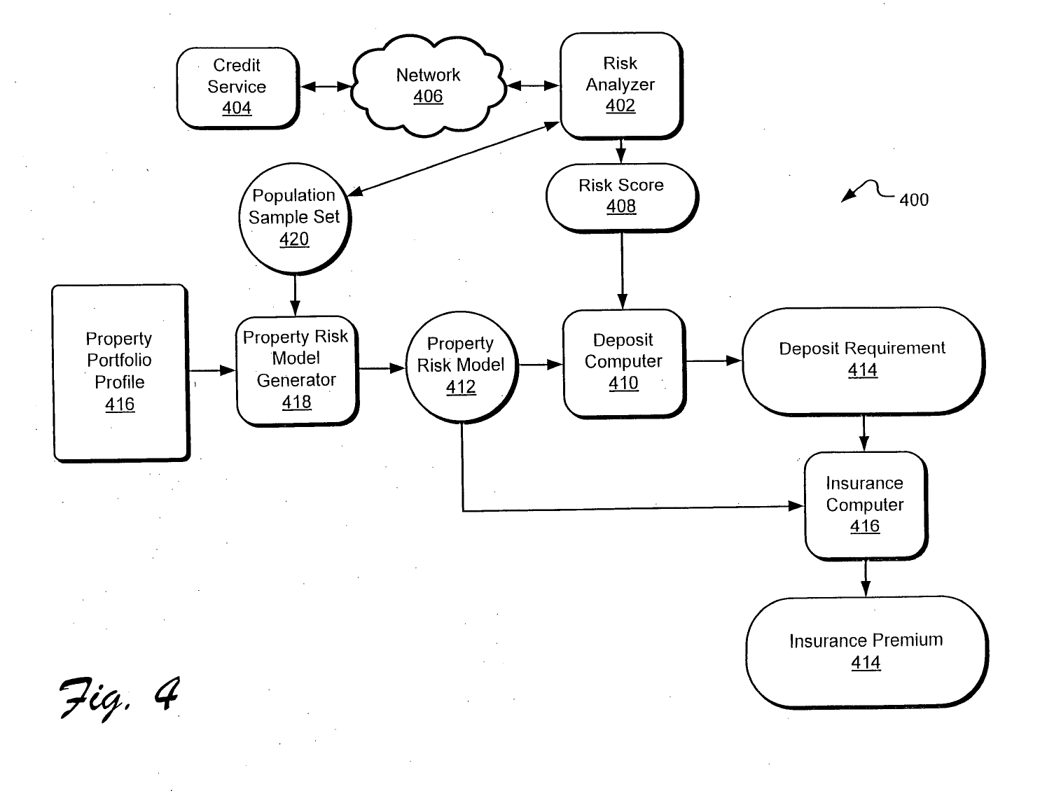

FIG. 4 illustrates with more detail an exemplary risk-based deposit computing system 400. A risk analyzer 402 inputs an applicant profile (e.g., as input manually by property manager, or as input from an onsite property management software system) and uses the profile to query a credit service 404 for a credit score. In many circumstances, this query is performed over a computing network 406, although other communications are also contemplated, including government postal services, courier services, and facsimile/telephone communications with the credit service 404. In some circumstances, the property manager may alternatively or additionally maintain and process their own credit scoring for applicants (such as a university housing organization). The risk analyzer 402 applies an applicant risk model to the applicant profile and credit score to generate a risk score 408.

A deposit computer 410 applies a property risk model 412 to the risk score 408 to generate a risk-based deposit requirement 414, which can be required of the applicant to obtain acceptance into the rental relationship. In contrast to the application risk model (applied by the risk analyzer 402), the property risk model 412 defines the risk tolerance associated with a given property. Different property and portfolio factors may be considered to determine a deposit requirement that satisfies a property's risk tolerance, including without limitation existing, historical, and desired occupancy rates; lease cycle timing; property condition (e.g., A, B, C, and D); location (e.g., nationally, within a given region, within a given city); location type (e.g., urban, suburban, rural); location within a given market or submarket, traffic volume; rent levels; subsidy status; financing status (e.g., Ullman restrictions for a tax-exempt bond financed property); landlord preferences; property amenities; resident types (e.g., senior housing, student housing, family housing, adult-only housing, etc.); legal restrictions; local custom (such as whether utilities are included in the rent or paid and contracted for directly by the tenant), etc. The factors are defined in a property portfolio profile 416.

A property risk model 412 is generated by a property risk model generator 418 based on the property portfolio profile 416 and a population sample set 420. A population sample set 420 includes data on current and historical property renters. In an apartment rental implementation, a population sample set may include payment performance during a lease term or some other relevant period, as well as other information characterizing a property's experience with renters. Property, in terms of the population sample set, may refer to a particular property unit (e.g., a particular apartment or vehicle) or other similar or identical property units in the same location or in a similar context (e.g., similar market characteristics, similar tenant types, similar geography, etc.). Payment performance for a given renter may be characterized by, but not limited to, by any of: late payments, evictions, skips, damage to a unit, other costs to the property manager caused by the renter, final net amounts owed to the property manager, and the deposit returned to the renter at the end of the rental period. This performance information is combined with the resident's risk score (which can be retrieved from the risk analyzer 402 for the individual renters in the population sample set 420) to define the historical risk/return tradeoff of that population (or conversely, the historical risk/cost correlation). A population sample set 420 may also be applied to rentals of other property, including leased vehicles, “rental” of air time on cell phones or rental of the cell phones themselves, rental of commercial real estate, office furniture rental, commercial equipment rental, etc.

In one implementation of the property risk model, a sample of actual performance data is derived from a sample of properties across several property types and geographies. Performance data is the rent payment history for a large number of actual renters through the life of their lease. Performance data would include whether rent was paid on time, whether the renter left the property owing money, caused any physical damage or caused other monetary damage to the property. Then historical credit information is derived on the same population of renters. This data is used retrospectively along with all of the property risk model parameters 308 to determine the relationship between property risk, renter credit risk and renter performance. These relationships will define a statistical model used in setting the property risk model.

By applying the risk score 408 to the property risk model 412 using the deposit computer 410 for a given applicant, the property manager can compute a deposit requirement that is tailored to compensate the property manager for a computed risk score, relative to a given property. In this manner, a property manager could ideally accept all applicants (for given optimal vacancies) knowing that the tailored deposit will balance the risk of less qualified applicants.

Nevertheless, it should be understood that at some point, the computed deposit requirement 414 may be too high for a given applicant to afford upfront. In such circumstances, an “insurance” product may be employed to spread the risk across many months and many renters. For example, if an applicant cannot afford the computed deposit requirement, a property manager may offer the applicant the opportunity to pay a different deposit along with a slightly higher periodic rent payment, which includes an insurance premium for an insurance product that will adequately compensate the property manager should the applicant get evicted, miss a payment, skip, cause property damage, etc.

An insurance computer 416 receives as input the property risk model 412, to which it applies the deposit requirement 414 to generate an insurance premium amount. In one implementation, the insurance computer 416 is operated by the property manager. In this implementation, the property manager may be self-insured or may rely on a third-party provider to provide the insurance coverage. In another implementation, the insurance computer 416 is operated by the property manager in combination with Web services or some other services provided by a third-party. For example, the property management software employed by the property manager may provide a user interface to a remote insurance service. It should also be understood that both the deposit requirement and the insurance premium can be adjusted to meet the applicant's financial needs.

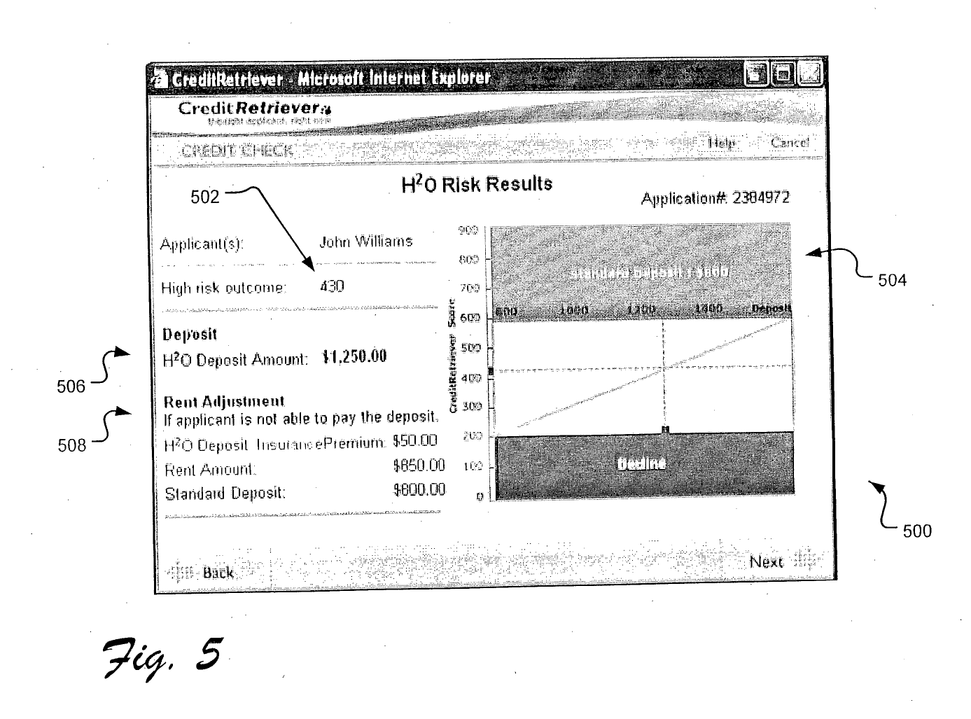

FIG. 5 illustrates an exemplary screenshot 500 of a results screen of a risk-based deposit computing system. The risk score computed for the applicant is 430, representing a “high risk” and a “Conditional Accept”. According to the illustrated risk results 504, a score of 0-300 results in a “Decline” and a score of 585-900 results in an “Accept”. Between 300 and 585, the result is a “Conditional Accept”.

However, given that the applicant falls between the “Decline” and “Accept” categories, the deposit computer computes a non-standard deposit 506 of $1250. In the illustrated risk results 504, the additional deposit amount varies linearly (and inversely) with the risk score. There is no additional deposit required at a score of 585, and there is an additional deposit of $800 required at a risk score of 300. It should be understood, however, that a risk-based deposit may be computed for the entire risk score range of 0-900, or for any sub-ranges therebetween.

The “Rent Adjustment” section 508 provides an alternative to an upfront deposit adjustment. If the applicant cannot afford a large deposit, he or she may elect to pay the standard deposit (e.g., $800), a monthly rent of $850, and an insurance premium of $50 per month. In this scenario, the applicant pays a little more over the period of a one year lease ($600 for insurance versus $450 in additional deposit) but spreads the payments over the period of the lease. The insurance premium calculation may include a calculation of the applicant's ability to pay based on income to rent and other credit variables. That calculation may require some up-front payment along with an insurance premium if the applicant's ability to pay requires a lower monthly rate.

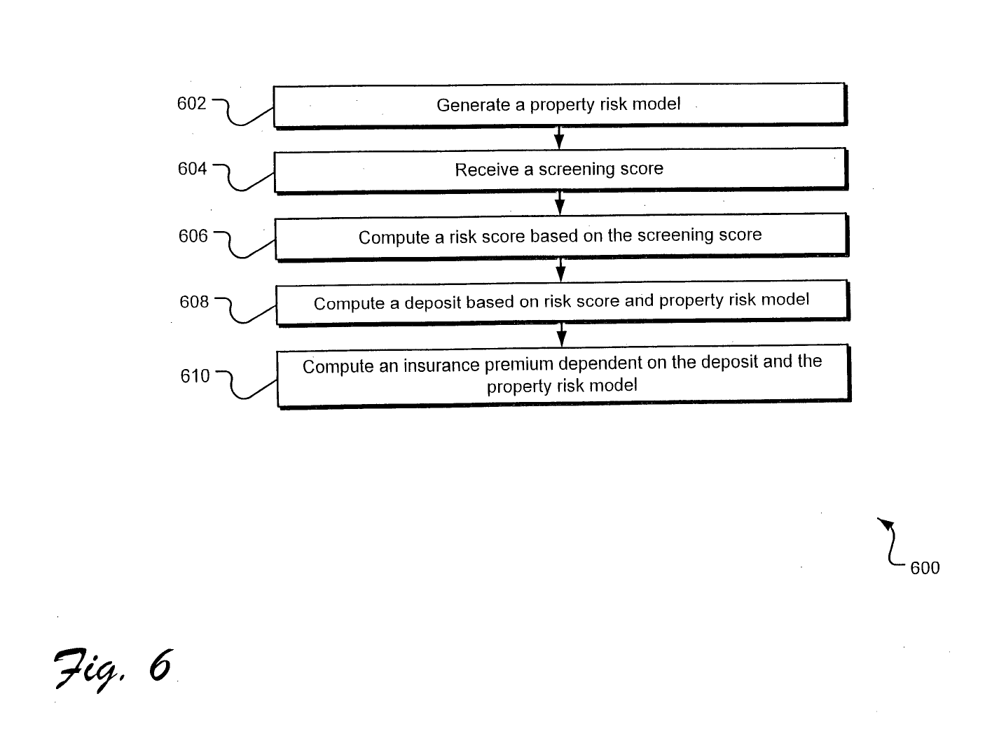

FIG. 6 illustrates exemplary operations 600 for computing a risk-based rental price. A modeling operation 602 generates a property risk model associated with one or more property units. For example, a property risk model may be specific to each unit in an apartment complex, each type of unit in an apartment complex or similar units in multiple apartment complexes. The property risk model is generated from a property portfolio profile and a population sample set.

In one implementation, a property risk model may be represented by a decision tree that is parameterized by values such as the Average Decline Rate or Desired Decline Rate, the Desired Vacancy/Occupancy, the Optimal Bad Debt Rate, and other characteristics. Decision points are set within the decision tree to categorize recommendations (e.g., Accept, Decline, etc.). The decision points model a tradeoff between risk of vacancy expense versus historical record of bad debt and other expenses relating to skips, evictions and other non-fulfillment of lease obligations. Within the recommendation categories, pricing factors can be assigned (e.g., per category or per increments within each category) to adjust the rental pricing. The decision tree and pricing factors may be developed from historical data.

A screening operation 604 receives a screening score, such as a credit score, a rental history, and/or criminal background check, from one or more screening services. An analysis operation 606 computes a risk score based on the screening score and an applicant risk model. A deposit operation 608 computes a deposit based on the risk score and the property risk mode.

An insurance operation 610 computes an insurance premium that is dependent on the previously computed deposit and the property risk model. In one implementation, the insurance premium is based on statistical relationships that provide the probability of default for a resident prospect (e.g., based on the applicant's credit risk) multiplied by the expected cost of default (e.g., for the property based on the property risk profile). As a result, a statistical table or matrix (similar to an insurance actuarial table) can be generated to relate an applicant credit risk score to an insurance premium for each property or each type of a property.

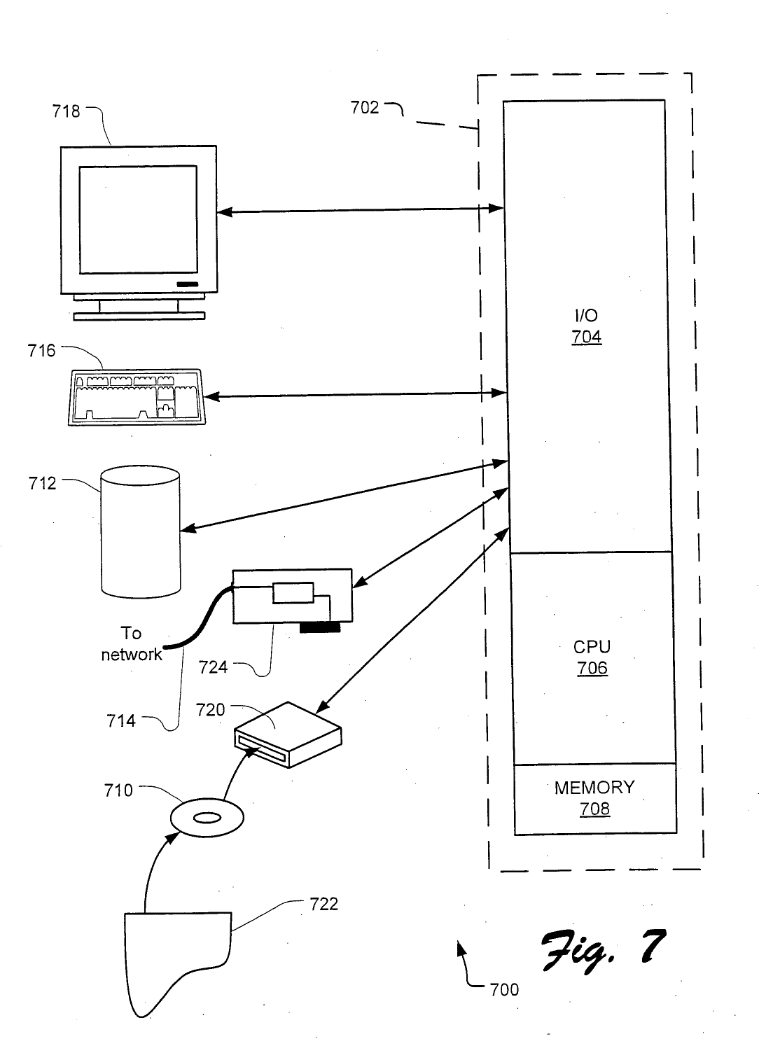

FIG. 7 illustrates an exemplary system useful in implementations of the described technology. A general purpose computer system 700 is capable of executing a computer program product to execute a computer process. Data and program files may be input to the computer system 700, which reads the files and executes the programs therein. Some of the elements of a general purpose computer system 700 are shown in FIG. 7 wherein a processor 702 is shown having an input/output (I/O) section 704, a Central Processing Unit (CPU) 706, and a memory section 708. There may be one or more processors 702, such that the processor 702 of the computer system 700 comprises a single central-processing unit 706, or a plurality of processing units, commonly referred to as a parallel processing environment. The computer system 700 may be a conventional computer, a distributed computer, or any other type of computer. The described technology is optionally implemented in software devices loaded in memory 708, stored on a configured DVD/CD-ROM 710 or storage unit 712, and/or communicated via a wired or wireless network link 714 on a carrier signal, thereby transforming the computer system 700 in FIG. 7 to a special purpose machine for implementing the described operations.

The I/O section 704 is connected to one or more user-interface devices (e.g., a keyboard 716 and a display unit 718), a disk storage unit 712, and a disk drive unit 720. Generally, in contemporary systems, the disk drive unit 720 is a DVD/CD-ROM drive unit capable of reading the DVD/CD-ROM medium 710, which typically contains programs and data 722. Computer program products containing mechanisms to effectuate the systems and methods in accordance with the described technology may reside in the memory section 704, on a disk storage unit 712, or on the DVD/CD-ROM medium 710 of such a system 700. Alternatively, a disk drive unit 720 may be replaced or supplemented by a floppy drive unit, a tape drive unit, or other storage medium drive unit. The network adapter 724 is capable of connecting the computer system to a network via the network link 714, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking enviromnent, the computer system 700 is connected (by wired connection or wirelessly) to a local network through the network interface or adapter 724, which is one type of communications device. When used in a WAN-networking environment, the computer system 700 typically includes a modem, a network adapter, or any other type of communications device for establishing communications over the wide area network. In a networked environment, program modules depicted relative to the computer system 700 or portions thereof, may be stored in a remote memory storage device. It is appreciated that the network connections shown are exemplary and other means of and communications devices for establishing a communications link between the computers may be used.

In an exemplary implementation, a risk analyzer module, a deposit computer module, an insurance computer module, a property risk model generator, and other modules may be incorporated as part of the operating system, application programs, or other program modules. Risk scores, screening scores, property portfolio profiles, population sample sets, and other data may be stored as program data.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended.

What is claimed is:

1. A method of computing a rental price for rental of a property by an applicant, the method comprising:
generating a risk score corresponding to the applicant, the risk score being dependent on a credit score of the applicant and rental history information of the application; and
computing the rental price dependent on the risk score.

2. The method of claim 1 wherein the rental price includes a deposit.

3. The method of claim 1 wherein the rental price includes a periodic rent payment.

4. The method of claim 1 wherein the rental price includes a periodic rent payment and an insurance premium.

5. The method of claim 1 further comprising:
generating a property risk model dependent on a property portfolio profile and historical payment performance information for the property, wherein the computing operation comprises applying the property risk model to the risk score to compute the rental price.

6. The method of claim 5 wherein the property portfolio profile defines a measure of risk tolerance associated with the property.

7. The method of claim 5 wherein the historical payment performance information defines payment performance by other renters in association the property.

8. The method of claim 1 further comprising:
computing an insurance premium corresponding to the rental price, based on the property risk model.

9. A computer program product encoding a computer program that executes a computer process for computing a rental price for rental of a property by an applicant, the computer process comprising:
generating a risk score corresponding to the applicant, the risk score being dependent on a credit score of the applicant and rental history information of the application; and
computing the rental price dependent on the risk score.

10. The computer program product of claim 9 wherein the rental price includes a deposit.

11. The computer program product of claim 9 wherein the rental price includes a periodic rent payment.

12. The computer program product of claim 9 wherein the rental price includes a periodic rent payment and an insurance premium.

13. The computer program product of claim 9 wherein the computer process further comprises:
generating a property risk model dependent on a property portfolio profile and historical payment performance information for the property, wherein the computing operation comprises applying the property risk model to the risk score to compute the rental price.

14. The computer program product of claim 13 wherein the property portfolio profile defines a measure of risk associated with the property.

15. The computer program product of claim 13 wherein the historical payment performance information defines payment performance by other renters in association the property.

16. The computer program product of claim 9 wherein the computer process further comprises:
computing an insurance premium corresponding to the rental price, based on the property risk model.

17. A system for computing a rental price for rental of a property by an applicant, the system comprising:
a risk analyzer that generates a risk score corresponding to the applicant, the risk score being dependent on a credit score of the applicant and rental history information of the application; and
a deposit computer module that determines the rental price dependent on the risk score.

18. The system of claim 17 wherein the rental price includes a deposit.

19. The system of claim 17 wherein the rental price includes a periodic rent payment.

20. The system of claim 17 wherein the rental price includes a periodic rent payment and an insurance premium.

21. The system of claim 17 further comprising:
a property risk model generator defining a property risk model dependent on a property portfolio profile and historical payment performance information for the property, wherein the deposit computer module applies the property risk model to the risk score to compute the rental price.

22. The system of claim 21 wherein the property portfolio profile defines a measure of risk tolerance associated with the property.

23. The system of claim 21 wherein the historical payment performance information defines payment performance by other renters in association the property.

24. The system of claim 17 wherein the computer process further comprises:
an insurance computer module that computes an insurance premium corresponding to the rental price, based on the property risk model.
